(19) United States
(12) Patent Application Publication
(10) Pub. No.: US 2025/0184129 A1
(43) Pub. Date: Jun. 5, 2025

(54) SYSTEM AND METHOD FOR GENERATING HIDDEN BIOMETRICS-BASED PASSWORDS

(71) Applicant: Amod Ashok Dange, Mountain View, CA (US)

(72) Inventors: Amod Ashok Dange, Mountain View, CA (US); Yash Mody, Mumbai (IN)

(21) Appl. No.: 19/050,160

(22) Filed: Feb. 11, 2025

Related U.S. Application Data
(63) Continuation-in-part of application No. 18/782,801, filed on Jul. 24, 2024.
Application No. 18/782,801 is a continuation-in-part of application No. 17/481,468, filed on Sep. 22, 2021, now Pat. No. 12,072,963.
Application No. 17/481,468 is a continuation-in-part of application No. 17/018,273, filed on Sep. 11, 2020, now Pat. No. 11,582,032.
(60) Provisional application No. 62/906,080, filed on Sep. 25, 2019.
(60) Provisional application No. 62/954,591, filed on Dec. 29, 2019.
(60) Provisional application No. 63/029,717, filed on May 26, 2020.

(51) Int. Cl. H04L 9/08; H04L 9/32

(52) U.S. Cl. CPC H04L 9/0866; H04L 9/0825; H04L 9/3226

(57) ABSTRACT

A system for generating passwords in real-time based on biometric factors is disclosed. The system registers users by computing a Secret-Key from biometric samples, generating a Public-Key, and storing them securely. User authentication involves capturing a real-time biometric sample, generating a Secret-Key, and comparing a computed Real-Time-Unique-Number with a stored Unique-Number. For password setting, the system detects application requirements, authenticates the user, generates a password by computing a Unique-Number using a stored Random-Number and the Secret-Key, and submits the password. For login, the system authenticates the user, retrieves the stored Random-Number, computes the Unique-Number, regenerates the password, and submits it. This biometric-based password generation system provides secure, user-friendly access without requiring password memorization. The method offers a novel approach to password management, enhancing security and user experience.

### CROSS-REFERENCE TO RELATED APPLICATIONS AND PRIORITY

The present application is a Continuation in Part (CIP) application of U.S. Complete application Ser. No. 18/782,801, filed on Jul. 24, 2024 entitled “System and method for managing an operating system using tokenized identity”, which claims priority from and is a CIP of U.S. Complete application Ser. No. 17/481,468, filed on Sep. 22, 2021 entitled “System and method for affixing a signature using biometric authentication”, which claims priority from and is a CIP of US Complete application Ser. No. 17/018,273 filed on Sep. 11, 2020 entitled “System and method for sharing user preferences without having the user reveal their identity”, which claims the benefit of U.S. Provisional Application No. 62/906,080 filed on Sep. 25, 2019 entitled “Method and system of managing personal and business information”, the U.S. Provisional Application No. 62/954,591 filed on Dec. 29, 2019 entitled “Method and system for anonymously matching consumers and businesses”, and also the U.S. Provisional Application No. 63/029,717 filed on May 26, 2020 entitled “Method and system of storing identity and signature using the human body as a node.”

### TECHNICAL FIELD

The present subject matter described herein, in general, relates to password management, and more particularly, to creating and regenerating secure passwords in real-time using biometric factors as seed data while maintaining compatibility with existing password-based authentication systems.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the digital age, password-based authentication remains a critical component of online security across various sectors. Despite the emergence of advanced authentication methods, passwords continue to serve as the primary means of access control for most digital services and systems. However, the current paradigm of password management presents numerous challenges that affect both individual users and organizations.

Statistical data reveals the scope of these challenges. As of October 2024, approximately 80% of organizations still rely on passwords to secure certain infrastructure types. This widespread dependence on password-based authentication creates a significant security burden, particularly given user behavior patterns. Studies indicate that 78% of individuals reuse passwords across multiple accounts, with 52% using the same password for at least three different accounts, and 4% extending this practice to eleven or more accounts.

The adoption of password management solutions remains concerningly low, with only 30% of Americans utilizing password managers. More alarmingly, 22% of users implement no security measures whatsoever to protect their passwords. According to recent surveys conducted in 2024, the primary causes of password compromise include weak password selection (35%), password reuse across multiple accounts (30%), organizational data breaches (27%), and phishing attacks (21%). Notably, 17% of users cannot identify how their passwords were compromised, highlighting a significant gap in security awareness.

While the technology industry is gradually moving towards passwordless authentication mechanisms, particularly those leveraging biometric factors, this transition faces several obstacles. The migration to entirely new authentication systems require substantial changes to existing infrastructure, making the process slow and resource-intensive. Additionally, the widespread deployment of password-less solutions necessitates coordination across diverse platforms and services, further complicating the transition.

Traditional password management approaches suffer from inherent limitations. Users must choose between memorizing complex passwords, which often leads to simplification and reuse, or utilizing password managers, which introduce their own security and usability concerns. The challenge of generating and maintaining strong, unique passwords for multiple accounts while ensuring both security and accessibility remains largely unresolved.

Furthermore, existing password generation methods typically rely on purely algorithmic approaches that, while capable of creating complex passwords, fail to incorporate user-specific factors that could enhance both security and usability. The disconnect between biometric authentication capabilities and traditional password requirements creates a technological gap that impacts system security and user experience.

In light of these challenges, users and organizations have long felt the need for a solution that bridges the gap between the security benefits of biometric authentication and the practical requirements of password-based systems. Such a solution should address the fundamental issues of password generation, management, and regeneration while maintaining compatibility with existing infrastructure and providing an enhanced security model that leverages modern biometric capabilities.

The present invention aims to address these long-standing needs by providing an innovative approach to password generation and management that leverages biometric authentication while maintaining compatibility with traditional password-based systems. This solution offers a path forward that enhances security without requiring wholesale changes to existing infrastructure, thereby providing immediate benefits while supporting the gradual transition to more advanced authentication methods.

### SUMMARY

This summary is provided to introduce concepts related to a system and for generating passwords in real-time based on biometric factors, which are further described below in the detailed description. This summary is not intended to identify essential features of the claimed subject matter nor is it intended for use in determining or limiting the scope of the claimed subject matter.

In one implementation, a system for generating passwords in real-time based on biometric factors is disclosed. The system comprises a processor and a memory coupled to the processor, wherein the processor is configured to execute instructions stored in the memory for registering a user based on a user registration process. The user registration process comprises steps of receiving a set of biometric samples of the user, corresponding to one or more biometric factors, processing the set of biometric samples to compute a Secret-Key (S1) corresponding to the user, generating a Unique-Number (N1) using a random number generation algorithm, applying a Function (F1) to the Secret-Key (S1) and the Unique-Number (N1) to compute a Public-Key (P1), storing the Unique-Number (N1) on a user device and in a data repository, and storing the Public-Key (P1) on a storage device.

Further, the processor is configured to execute instructions stored in the memory for authenticating the user based on a user authentication process, wherein the user authentication process comprises steps of receiving a biometric sample captured from the user in real-time, processing the biometric sample to generate a Secret-Key (S2), fetching the Public-Key (P1) corresponding to the user from the user device, computing a Real-Time-Unique-Number (N2) using the Public-Key (P1), the Secret-Key (S2) and the Function (F1), and authenticating the user based in comparison of the Real-Time-Unique-Number (N2) with the Unique-Number (N1) stored on the user device.

Further, the processor is configured to execute instructions stored in the memory for receiving a password setting request or a password saving request corresponding to a target application, wherein the password setting request corresponds to setting a Password (PW1) on the target application, and wherein the password setting request is processed by receiving the password setting request from the user for setting the Password (PW1) on the target application, detecting from the target application, a target application identifier, detecting from the target application, or receiving, through user input, or through an API endpoint, a username associated with a username corresponding to the target application, detecting from the target application, or receiving, through user input, or through an API endpoint, password length and character type requirements for the target application, authenticating the user based on the user authentication process, and generating the Password (PW1) by generating a Random-Number (R1) using a random number generation algorithm, saving the Random-Number (R1) in a local database and associating the Random-Number (R1) with the username corresponding to the target application, computing a Unique-Number (R2) using the Random-Number (R1) stored in the local database, the Secret Key (S2), and a Function (F2), transforming the Unique-Number (R2) into the Password (PW1), wherein the Password (PW1) complies with the password length and character type requirements for the target application, pasting the username in the username input field on the target application, pasting the Password (PW1) in the password input field on the target application, and triggering the submission action on the target application for setting the Password (PW1) on the target application.

Further, the processor is configured to execute instructions stored in the memory for processing a password regeneration request from the user when the user begins to login on the target application, wherein the password regeneration request is processed by receiving the password regeneration request from the user, detecting from the target application, the target application identifier, fetching, from the local database, the username associated with the user account on the target application based on the target application identifier, authenticating the user based on the user authentication process and retrieving the Secret Key (S2) generated in real-time based on the user authentication process, regenerating a Real-Time-Password (PW2) by fetching, from the local database, the Random-Number (R1) associated with the user account on the target application, computing the Unique-Number (R2) using the Random-Number (R1) stored on the local device, the Secret Key (S2), and the Function (F2), transforming the Unique-Number (R2), and regenerating the Real-Time-Password, pasting the username in the username input field on the target application, pasting the Real-Time-Password (PW2) in the password input field on the target application, and triggering a submission action on the target application, wherein the user obtains access to the target application based on successful password verification.

In one implementation, a method for generating passwords in real-time based on biometric factors is disclosed. The method comprises steps for registering a user based on a user registration process. The user registration process comprises steps of receiving a set of biometric samples of the user, corresponding to one or more biometric factors, processing the set of biometric samples to compute a Secret-Key (S1) corresponding to the user, generating a Unique-Number (N1) using a random number generation algorithm, applying a Function (F1) to the Secret-Key (S1) and the Unique-Number (N1) to compute a Public-Key (P1), storing the Unique-Number (N1) on a user device and in a data repository, and storing the Public-Key (P1) on a storage device.

Further, the method comprising steps for authenticating the user based on a user authentication process, wherein the user authentication process comprises steps of receiving a biometric sample captured from the user in real-time, processing the biometric sample to generate a Secret-Key (S2), fetching the Public-Key (P1) corresponding to the user from the user device, computing a Real-Time-Unique-Number (N2) using the Public-Key (P1), the Secret-Key (S2) and the Function (F1), and authenticating the user based in comparison of the Real-Time-Unique-Number (N2) with the Unique-Number (N1) stored on the user device.

Further, the method comprising steps for receiving a password setting request or a password saving request corresponding to a target application, wherein the password setting request corresponds to setting a Password (PW1) on the target application, and wherein the password setting request is processed by receiving the password setting request from the user for setting the Password (PW1) on the target application, detecting from the target application, a target application identifier, detecting from the target application, or receiving, through user input, or through an API endpoint, a username associated with a username corresponding to the target application, detecting from the target application, or receiving, through user input, or through an API endpoint, password length and character type requirements for the target application, authenticating the user based on the user authentication process, and generating the Password (PW1) by generating a Random-Number (R1) using a random number generation algorithm, saving the Random-Number (R1) in a local database and associating the Random-Number (R1) with the username corresponding to the target application, computing a Unique-Number (R2) using the Random-Number (R1) stored in the local database, the Secret Key (S2), and a Function (F2), transforming the Unique-Number (R2) into the Password (PW1), wherein the Password (PW1) complies with the password length and character type requirements for the target application, pasting the username in the username input field on the target application, pasting the Password (PW1) in the password input field on the target application, and triggering the submission action on the target application for setting the Password (PW1) on the target application.

Further, the method comprising steps for processing a password regeneration request from the user when the user begins to login on the target application, wherein the password regeneration request is processed by receiving the password regeneration request from the user, detecting from the target application, the target application identifier, fetching, from the local database, the username associated with the user account on the target application based on the target application identifier, authenticating the user based on the user authentication process and retrieving the Secret Key (S2) generated in real-time based on the user authentication process, regenerating a Real-Time-Password (PW2) by fetching, from the local database, the Random-Number (R1) associated with the user account on the target application, computing the Unique-Number (R2) using the Random-Number (R1) stored on the local device, the Secret Key (S2), and the Function (F2), transforming the Unique-Number (R2), and regenerating the Real-Time-Password, pasting the username in the username input field on the target application, pasting the Real-Time-Password (PW2) in the password input field on the target application, and triggering a submission action on the target application, wherein the user obtains access to the target application based on successful password verification.

In one implementation, a computer program product having a processor and a non-transitory, machine-readable storage medium for generating passwords in real-time based on biometric factors is disclosed. The computer program product comprising a program code for registering a user based on a user registration process. The user registration process comprises steps of receiving a set of biometric samples of the user, corresponding to one or more biometric factors, processing the set of biometric samples to compute a Secret-Key (S1) corresponding to the user, generating a Unique-Number (N1) using a random number generation algorithm, applying a Function (F1) to the Secret-Key (S1) and the Unique-Number (N1) to compute a Public-Key (P1), storing the Unique-Number (N1) on a user device and in a data repository, and storing the Public-Key (P1) on a storage device.

Further, the computer program product comprising a program code for authenticating the user based on a user authentication process, wherein the user authentication process comprises steps of receiving a biometric sample captured from the user in real-time, processing the biometric sample to generate a Secret-Key (S2), fetching the Public-Key (P1) corresponding to the user from the user device, computing a Real-Time-Unique-Number (N2) using the Public-Key (P1), the Secret-Key (S2) and the Function (F1), and authenticating the user based in comparison of the Real-Time-Unique-Number (N2) with the Unique-Number (N1) stored on the user device.

Further, the computer program product comprising a program code for receiving a password setting request or a password saving request corresponding to a target application, wherein the password setting request corresponds to setting a Password (PW1) on the target application, and wherein the password setting request is processed by receiving the password setting request from the user for setting the Password (PW1) on the target application, detecting from the target application, a target application identifier, detecting from the target application, or receiving, through user input, or through an API endpoint, a username associated with a username corresponding to the target application, detecting from the target application, or receiving, through user input, or through an API endpoint, password length and character type requirements for the target application, authenticating the user based on the user authentication process, and generating the Password (PW1) by generating a Random-Number (R1) using a random number generation algorithm, saving the Random-Number (R1) in a local database and associating the Random-Number (R1) with the username corresponding to the target application, computing a Unique-Number (R2) using the Random-Number (R1) stored in the local database, the Secret Key (S2), and a Function (F2), transforming the Unique-Number (R2) into the Password (PW1), wherein the Password (PW1) complies with the password length and character type requirements for the target application, pasting the username in the username input field on the target application, pasting the Password (PW1) in the password input field on the target application, and triggering the submission action on the target application for setting the Password (PW1) on the target application.

Further, the computer program product comprising a program code for processing a password regeneration request from the user when the user begins to login on the target application, wherein the password regeneration request is processed by receiving the password regeneration request from the user, detecting from the target application, the target application identifier, fetching, from the local database, the username associated with the user account on the target application based on the target application identifier, authenticating the user based on the user authentication process and retrieving the Secret Key (S2) generated in real-time based on the user authentication process, regenerating a Real-Time-Password (PW2) by fetching, from the local database, the Random-Number (R1) associated with the user account on the target application, computing the Unique-Number (R2) using the Random-Number (R1) stored on the local device, the Secret Key (S2), and the Function (F2), transforming the Unique-Number (R2), and regenerating the Real-Time-Password, pasting the username in the username input field on the target application, pasting the Real-Time-Password (PW2) in the password input field on the target application, and triggering a submission action on the target application, wherein the user obtains access to the target application based on successful password verification.

### Definitions

‘Biometric Sample’ refers to a digital representation of one or more physical or behavioral characteristics of a user, such as facial features, fingerprints, voice patterns, iris scans, or other unique biological identifiers used for authentication.

‘Secret-Key (S1, S2)’ refers to a cryptographic key derived from processing biometric samples, which serves as a unique identifier that cannot be reverse-engineered to reveal the original biometric data.

‘Unique-Number (N1)’ refers to a randomly generated numerical value created during user registration that serves as part of the user's authentication credentials and is stored securely on the user device.

‘Public-Key (P1)’ refers to a cryptographically derived key computed using the Secret-Key and Unique-Number, which can be safely stored and shared without compromising the security of the system.

‘Real-Time-Unique-Number (N2)’ refers to a dynamically generated number computed during the authentication process using the Public-Key, current Secret-Key, and cryptographic function to verify user identity.

‘Random-Number (R1)’ refers to a securely generated random value associated with a specific username and target application, stored in the local database for password regeneration.

‘Unique-Number (R2)’ refers to a dynamically computed number generated using the stored Random-Number, current Secret-Key, and cryptographic function for password generation.

‘Function (F1)’ is a function based on Asymmetric Key Encryption. ‘Function (F2)’ is a function based on Asymmetric Key Encryption.

‘Transformer Algorithm’ refers to a set of rules and procedures that convert the Unique-Number into a password string compliant with specified password length and character type requirements.

‘Target Application’ refers to any software system, website, or service that requires password-based authentication.

‘Local Database’ refers to a secure storage system on the user device that maintains the associations between usernames, Random-Numbers, and target applications.

‘Password Character Requirements’ refers to the set of rules specifying allowed character types, minimum and maximum length, and other constraints for password validation.

‘Biometric Authentication’ refers to the process of verifying a user's identity through the comparison of captured biometric data with previously registered biometric credentials.

‘Password Regeneration’ refers to the process of dynamically recreating a previously generated password using stored Random-Numbers and current biometric authentication.

‘Static-Password (SPW1, SPW2)’ refers to an existing password that a user wants to securely store in the system, where SPW1 is the original password provided by the user and SPW2 is the reconstructed version during password recall.

‘Proxy-Password (PPW1)’ refers to a cryptographically transformed version of a Static-Password that is safe for storage and can only be reversed to reveal the original password through proper biometric authentication.

‘Password Recall’ refers to the process of retrieving and reconstructing a previously saved Static-Password using the stored Proxy-Password and current biometric authentication.

### BRIEF DESCRIPTION OF DRAWINGS

The detailed description is described with reference to the accompanying Figures. The same numbers are used throughout the drawings to refer to features and components.

FIG. 1 illustrates a system for generating passwords in real-time based on biometric factors, in accordance with an embodiment of the present disclosure.

FIG. 2 illustrates components of the system for generating passwords in real-time based on biometric factors, in accordance with an embodiment of the present disclosure.

FIG. 3 illustrates a method for generating passwords in real-time based on biometric factors, in accordance with an embodiment of the present disclosure.

FIG. 4 illustrates a method for user registration in the system for generating passwords in real-time based on biometric factors, in accordance with an embodiment of the present disclosure.

FIG. 5 illustrates a method for user authentication in the system for generating passwords in real-time based on biometric factors, in accordance with an embodiment of the present disclosure.

FIG. 6 illustrates a method for processing a password setting request in the system for generating passwords in real-time based on biometric factors, in accordance with an embodiment of the present disclosure.

FIG. 7 illustrates a method for processing a password regeneration request during user login in the system for generating passwords in real-time based on biometric factors, in accordance with an embodiment of the present disclosure.

FIG. 8 illustrates a method for processing a password saving request, in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

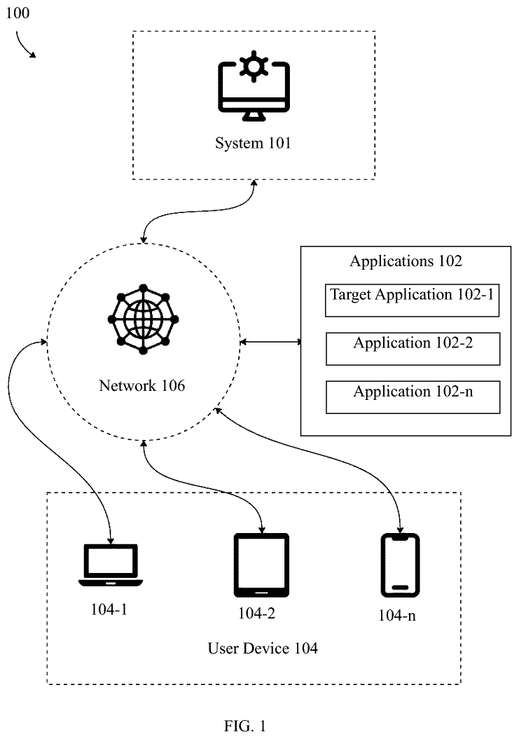

Referring now to FIG. 1, implementation 100 of system 101 for generating passwords in real-time based on biometric factors is illustrated, in accordance with an embodiment of the present subject matter. In one embodiment, the system 101 may comprise a processor and a memory. Further, the system 101 may be connected to user devices and Applications through a network 104. It may be understood that the system 101 may be communicatively coupled with multiple users through one or more User devices 103-1, 103-2, 103-3 . . . , 103-n and Applications 102-1, 102-2, 102-3 . . . , 102-n collectively referred to as a user device 103 and Applications 102.

In one embodiment, the network 104 may be a cellular communication network used by user devices 103 such as mobile phones, tablets, or a virtual device. In one embodiment, the cellular communication network may be the Internet. The user device 103 may be any electronic device, communication device, image capturing device, machine, software, automated computer program, a robot or a combination thereof. Further the Applications 102 may be any software system, website, or service that requires password-based authentication. The system 101 may be configured to register users over the system 101. Further, the system 101 may be configured to authenticate the user, each time the user makes a request to access the system 101.

In one embodiment, the user devices 103 are enabled with biometric scanning capabilities. Further, the user devices 103 may support communication with the system 101 over one or more types of networks in accordance with the described embodiments. For example, some user devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. The aforementioned user devices 103 and network 104 may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others.

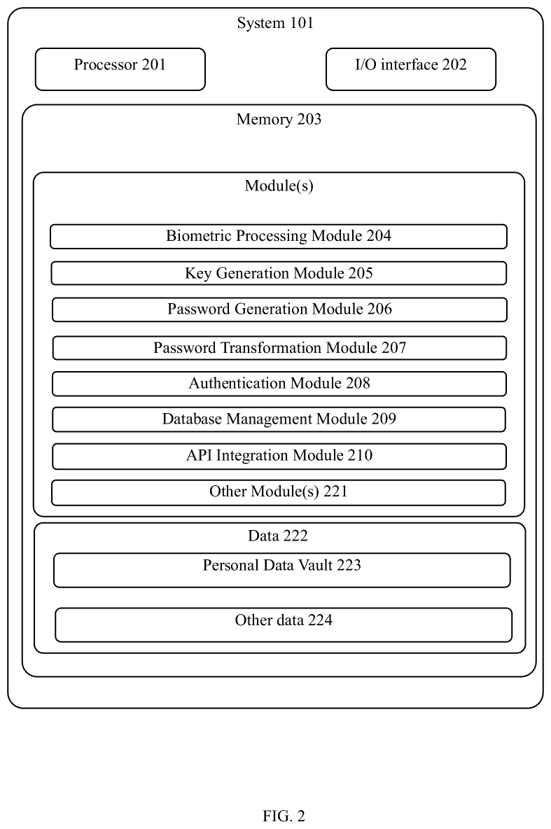

In an embodiment, the system 101 includes various modules for handling different aspects of the password generation and management process. The system 101 provides a secure way to manage passwords by utilizing biometric authentication while maintaining compatibility with existing password-based systems. In order to enable a user to login into a Target Application 102-1, from the Applications 102, the System 101 performs five key processes: Registration, Authentication, Password Generation, Password Saving, and Password Regeneration. Throughout these processes, the system 101 maintains security by never storing actual passwords or biometric data. Instead, it stores Random-Numbers and Proxy-Passwords along with their associations with usernames, regenerating passwords on demand through biometric authentication. This approach combines the convenience of password managers with the security of biometric authentication while maintaining compatibility with existing password-based systems. The system supports both generating new passwords and securely storing existing passwords through a proxy-based encryption mechanism. The transformer algorithm ensures that generated passwords comply with the requirements of the Target Application 102-1, while maintaining consistency across regenerations. This enables the system 101 to work seamlessly with existing applications without requiring modifications to their authentication systems. By implementing these five core processes, the system 101 provides a secure and user-friendly solution to password management that bridges the gap between traditional password-based authentication and modern biometric security methods. The password generation, saving, and management processes are further illustrated with the block diagram in FIG. 2.

Referring now to FIG. 2, various components of the System 101 are illustrated, in accordance with an embodiment of the present subject matter. As shown, the system 101 may include at least one processor 201, an I/O Interface 202 and a memory 203. The memory 203 consists of a set of modules. The set of modules may include a Biometric Processing Module 204, a Key Generation Module 205, a Password Generation Module 206, a Password Transformation Module 207, an Authentication Module 208, a Database Management Module 209, an API Integration Module 210, Password Saving Module 211 and Other Modules 212. In one embodiment, the at least one processor 201 is configured to fetch and execute computer-readable instructions, stored in the memory 203, corresponding to each module.

In one embodiment, the memory 203 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and memory cards.

In one embodiment, the programmed instructions may include routines, programs, objects, components, data structures, etc., which perform particular tasks, functions, or implement particular abstract data types. The data 212 may comprise a Secure Storage Vault 213, and other data 214. The Secure Storage Vault 213 is configured to maintain the Random-Numbers (R1), usernames, and application associations for each user. The Secure Storage Vault 213 may be implemented as an encrypted local database, ensuring secure and controlled access to this critical information. The other data 214 serves as a repository for storing data processed, received, and generated by one or more components and programmed instructions.

The processor 201 is configured to execute various modules that collectively implement the biometric password generation and management system. Each module is designed to handle specific aspects of the system as defined in the claims, working together to provide secure and seamless password management through biometric authentication.

In one embodiment, the processor 201 may be configured for executing programmed instructions corresponding to the Biometric Processing Module 204. The Biometric Processing Module 204 serves as the foundational component of the system's biometric processing capabilities, handling all operations related to the capture, processing, and initial analysis of biometric data. The Biometric Processing Module 204 enables it to process multiple types of biometric factors simultaneously, including facial features, voice patterns, retinal scans, fingerprints, and palm vein patterns.

The Biometric Processing Module 204 implements a comprehensive processing pipeline that begins with the reception of biometric samples. During the registration phase, the Biometric Processing Module 204 systematically processes multiple samples for each biometric factor to establish a robust baseline template. This multi-sample approach ensures the creation of reliable biometric references while accounting for natural variations in biometric presentations.

The Key Generation Module 205 represents a critical security component that works in synchronized operation with the Biometric Processing Module 204. This module implements the cryptographic foundation of the system 101, employing sophisticated asymmetric encryption techniques to transform biometric data into secure cryptographic keys while ensuring that the original biometric information cannot be reverse-engineered from the generated keys.

During the registration process, the Key Generation Module 205 orchestrates a series of cryptographic operations. The process begins with the computation of the initial Secret-Key (S1), which is derived from the processed biometric data using specialized algorithms that maintain the uniqueness of the biometric features while converting them into a cryptographically suitable format. The Key Generation Module 205 then generates the Unique-Number (N1) using a cryptographically secure random number generator that ensures both uniqueness and unpredictability. This Unique-Number serves as a critical component in the system's security architecture.

The Key Generation Module 205 implements Function (F1), a sophisticated asymmetric encryption function that combines the Secret-Key (S1) and Unique-Number (N1) to compute the Public-Key (P1). The Function (F1) is function based on Asymmetric Key Encryption that prevents any possibility of reverse engineering the Secret-Key (S2). The mathematical properties of Function (F1) ensure that while it consistently produces the same Public-Key (P1) for given inputs, it is computationally infeasible to derive the original inputs from the Public-Key (P1).

In an embodiment, the Function (F1) may implement Asymmetric Key Encryption using elliptic curve cryptography (ECC). Specifically, Function (F1) may use the Secret-Key (S1) as the private key input and combine it with the Unique-Number (N1) through point multiplication on the selected elliptic curve. The Secret-Key (S1) acts as the scalar multiplier while the Unique-Number (N1) is used to derive the base point on the curve. This multiplication results in a point on the curve that becomes the Public-Key (P1). The one-way nature of ECC ensures that even with knowledge of P1 and N1, it remains computationally infeasible to derive S1, thereby maintaining the security of the biometric-derived secret key while enabling reliable authentication through the derived public key.

For instance, in a practical implementation of the system 101, when processing a user's facial biometric data, the Key Generation Module 205 operate in a coordinated sequence. The Biometric Processing Module 204 first captures a high-resolution facial image through the device's camera system. This image undergoes intensive processing that includes spatial normalization, illumination correction, and feature point extraction. The resulting feature vector is then passed to the Key Generation Module 205, which applies its cryptographic functions to generate the necessary keys while maintaining the security of the biometric data. This entire process occurs in secure memory, with sensitive data being immediately discarded after use.

The security architecture implemented by the Key Generation Module 205 ensures that no raw biometric data or Secret-Keys are ever stored persistently. Instead, only the Public-Key (P1) and Unique-Number (N1) are retained, with the Public-Key (P1) serving as the user's base identifier while the Unique-Number (N1) is securely stored both on the user's device and in the system's secure data repository. This dual-storage approach provides both security and reliability while maintaining the system's ability to authenticate users across different devices.

In one embodiment, the processor 201 may be configured for executing programmed instructions corresponding to the Password Generation Module 206. The Password Generation Module 206 implements a comprehensive password management system that encompasses both the generation of new passwords and the secure storage of existing passwords through an advanced proxy-based encryption architecture. The module's functionality extends beyond traditional password generation to provide a complete password lifecycle management solution. For new password creation, the module processes password setting requests through a sophisticated pipeline that combines biometric authentication with cryptographic techniques to generate secure, application-specific passwords. When handling existing passwords, the module implements a secure storage mechanism that transforms user-provided Static-Passwords into encrypted Proxy-Passwords using biometric-derived keys. This dual capability allows users to maintain a unified password management approach regardless of whether they are creating new accounts or securing existing credentials. The Password Generation Module 206 maintains continuous interaction with Target Application 102-1, gathering essential information such as application identifiers, usernames, and password requirements through multiple channels including API communication, password policy analysis, and user input when necessary. This adaptable approach ensures broad compatibility across diverse applications while maintaining rigorous security standards. The module's architecture is specifically designed to handle the complexities of modern password requirements, supporting various authentication scenarios while ensuring that security is never compromised for convenience. Through its integration with the biometric processing pipeline, the module ensures that all password operations, whether generation or storage, are intrinsically linked to the user's biometric identity, providing a seamless yet highly secure user experience.

Once the Password Generation Module 206 has collected the necessary parameters, it generates a Random-Number (R1) using cryptographically secure random number generation algorithms. This Random-Number serves as a unique identifier for each application-specific password. The Password Generation Module 206 then orchestrates the interaction between the current biometric Secret-Key (S2) and the Random-Number (R1) using Function (F2), producing a Unique-Number (R2). This operation ensures that each generated password is uniquely tied to both the user's biometric identity and the specific application context. The Function (F2) is a function based on Asymmetric Key Encryption that prevents any possibility of reverse engineering the Secret-Key (S2). The Password Generation Module 206 implements a consistent password regeneration flow that ensures the same password is generated for a given application when needed. This involves retrieving the stored Random-Number (R1) from the Secure Storage Vault 213, combining it with the real-time biometric-derived Secret-Key (S2), and applying the same transformation process to recreate the exact password previously generated for that application.

The Password Transformation Module 207 works in close conjunction with the Password Generation Module 206 to ensure that generated passwords meet application-specific requirements. The Password Transformation Module 207 implements a sophisticated transformer algorithm that analyzes and enforces password requirements. The Password Transformation Module 207 systematically identifies required character types, including uppercase letters, lowercase letters, numbers, and special characters, and ensures that generated passwords include all mandatory elements while meeting length constraints.

The Password Transformation Module 207 is configured to verify password complexity rules. The Password Transformation Module 207 implements pattern analysis algorithms that check for and prevent consecutive character repetitions, common sequences, and other patterns that might weaken password security. Before finalizing any password, the Password Transformation Module 207 validates it against the complete set of identified requirements, ensuring full compliance with the target application's password policy.

The Authentication Module 208 serves as the security gateway for all password-related operations. This Authentication Module 208 implements the biometric authentication process, ensuring that password generation and regeneration can only occur after successful biometric verification. The Authentication Module 208 coordinates with the Biometric Processing Module 204 to capture and process real-time biometric samples, and works with the Key Generation Module 205 to perform the necessary cryptographic validations.

The Database Management Module 209 provides secure storage and management of critical system data. The Database Management Module 209 maintains associations between usernames, Random-Numbers (R1), and Target Application 102-1. The Database Management Module 209 implements encrypted storage mechanisms to protect this sensitive data, while providing efficient retrieval capabilities for password regeneration operations. Importantly, the module never stores actual passwords, maintaining the system's “invisible password” security model where passwords are generated only when needed and immediately discarded after use.

The API Integration Module 210 facilitates seamless interaction with Target Application 102-1. The API Integration Module 210 is configured for detecting application identifiers, usernames, and password requirements through API endpoints. The API Integration Module 210 implements advanced form detection and automation capabilities, enabling it to identify username and password input fields on target application interfaces, automatically populate these fields with the appropriate credentials, trigger form submission actions while ensuring proper timing and execution, and handle various web form implementations and security measures. The module manages the automated input of generated passwords into application interfaces, coordinating with the target application's authentication forms to provide a streamlined user experience while maintaining security.

All these modules work in concert to deliver a comprehensive password management solution that leverages biometric authentication while maintaining compatibility with existing password-based systems. The modular architecture ensures that the system can be extended and enhanced while maintaining its core security properties.

The system's practical implementation can be best understood through real-world usage scenarios that demonstrate the intricate interactions between various modules. These examples illustrate how the system 101 maintains security while providing seamless user experience.

A common use case involves a user creating a new account on a banking application. This scenario demonstrates the sophisticated interplay between multiple system modules, each performing specialized functions while maintaining strict security protocols. The process unfolds through several distinct but interconnected phases that showcase the system's capabilities.

The sequence begins with the Authentication Module 208 initiating the biometric verification process. The system activates the device's camera to capture the user's facial biometry in high resolution, typically at 1280×720 pixels or more to ensure adequate detail. The Biometric Processing Module 204 then processes this capture through a sophisticated pipeline that identifies 128 distinct facial landmarks and generates a comprehensive feature vector. The Key Generation Module 205 may transform this 2048-bit feature vector into a 256-bit Secret-Key (S2), with the entire authentication process completing in less than one second, ensuring a responsive user experience.

Following successful authentication, the Password Generation Module 206 engages with the banking application's specific requirements. Modern banking applications typically mandate passwords between 12 and 16 characters, requiring a mix of uppercase and lowercase letters, numbers, and special symbols. The system addresses these requirements while enforcing additional security measures, such as preventing consecutive repeated characters and avoiding common dictionary words. The module generates a 32-byte Random-Number (R1) using cryptographically secure methods, then applies the Secret-Key (S2) through a Hash-based message authentication code (HMAC) function to produce the Unique-Number (R2). This process culminates in generating a compliant Password (PW1) like “X9k #mP2$vL5nJ” that meets all security requirements while remaining regeneratable through the system's cryptographic functions. The generated Password (PW1) can then be used for sign in to the Target Application 102-1.

In an embodiment, the processor may be configured to execute programmed instructions corresponding to the Password Saving Module 211 for implementing a sophisticated password saving workflow that addresses the critical need to securely store existing passwords while maintaining the high security standards of biometric authentication. When a user initiates the password saving process, the Password Saving Module 211 first receives the Static-Password along with its associated username and target application details. This information is immediately processed through a secure pipeline that transforms the Static-Password into a Proxy-Password using the real-time biometric-derived Secret Key and Function (F2). This transformation ensures that the original password is never stored directly in the system's database, providing an additional layer of security against potential data breaches. The system's password recall mechanism operates seamlessly when users need to access their stored passwords. Upon receiving a password recall request, the Password Saving Module 211 first authenticates the user through biometric verification, generating a fresh Secret Key from the current biometric sample. This key, combined with the stored Proxy-Password through Function (F2), allows the system to reconstruct the original Static-Password accurately. The reconstructed password is then automatically inserted into the appropriate login form, providing a frictionless user experience while maintaining security. Throughout this process, the Password Saving Module 211 maintains strict security protocols, ensuring that all cryptographic operations occur in secure memory and that sensitive data is immediately cleared after use. This approach effectively bridges the gap between security and usability, allowing users to maintain their existing passwords while benefiting from the enhanced security of biometric authentication. The system's ability to handle both generated and saved passwords through a unified interface provides users with a comprehensive password management solution that adapts to their specific needs while maintaining consistent security standards across all password operations.

The Password Saving Module 211 implements a sophisticated credential mapping system that maintains strict one-to-one relationships between Static-Passwords and their corresponding usernames within each target application context. When processing a Static-Password (SPW1), the module creates secure associations that link the password to both the specific username and the target application identifier. This three-way binding ensures that during subsequent password recall operations, the system can accurately retrieve and reconstruct the correct password for each unique username-application combination. The module employs sophisticated database schemas and encryption mechanisms to maintain these associations while ensuring that no direct password information is ever stored.

The Password Saving Module 211 utilizes Function (F2) in two distinct but complementary operations: password transformation and password reconstruction. During the saving process, Function (F2) implements a specialized form of asymmetric encryption that transforms the Static-Password into a Proxy-Password while binding it cryptographically to the user's biometric identity. During password recall, the same function enables authorized reconstruction of the original password through proper biometric authentication. This bidirectional capability is carefully engineered to maintain security throughout both operations, ensuring that password reconstruction is only possible with valid biometric authentication while preventing any unauthorized access to the original password data.

The module includes advanced password validation capabilities that ensure saved passwords comply with target application requirements. When processing a Static-Password, the module analyzes and validates the password against the target application's specific length and character type requirements. This validation ensures that both saved and recalled passwords maintain compatibility with application-specific password policies while preserving the exact composition of the original password. The module maintains this password integrity across multiple save and recall operations, ensuring consistent and reliable access to user credentials.

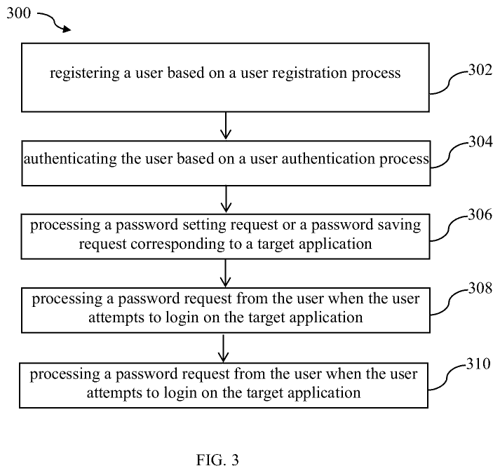

Referring to FIG. 3, a method 300 for generating passwords in real-time based on biometric factors is illustrated, in accordance with an embodiment of the present subject matter.

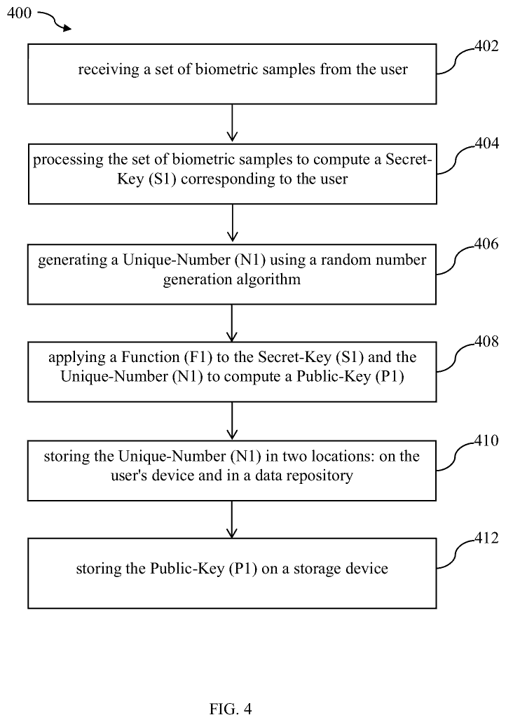

At Step 302, the processor 201 is configured for registering a user based on a user registration process. This fundamental step establishes the user's identity within the system 101 through biometric authentication. The registration process captures the user's biometric samples, processes them to create a Secret-Key, generates a Unique-Number, and computes a Public-Key using asymmetric encryption. These components form the foundation of the user's secure identity in the system 101. The process for user registration is further elaborated with reference to FIG. 4.

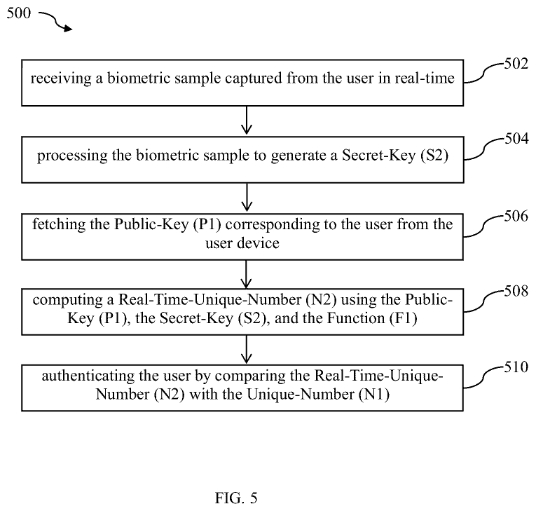

At Step 304, the processor 201 is configured for authenticating the user based on a user authentication process. This step ensures secure access to the system by verifying the user's identity through real-time biometric capture and cryptographic validation. The authentication process captures fresh biometric data, generates a new Secret-Key, and compares it with stored credentials to validate the user's identity. The process utilizes the Public-Key and Function (F1) to compute a Real-Time-Unique-Number for comparison with the stored Unique-Number. The process for user authentication is further elaborated with reference to FIG. 5.

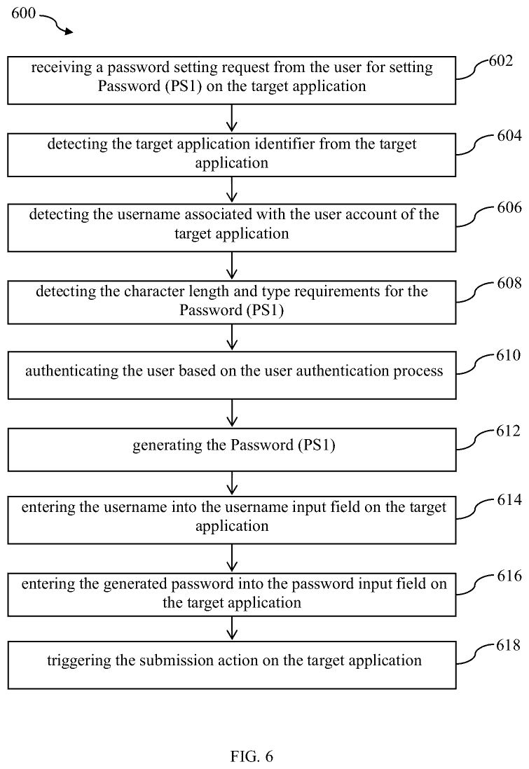

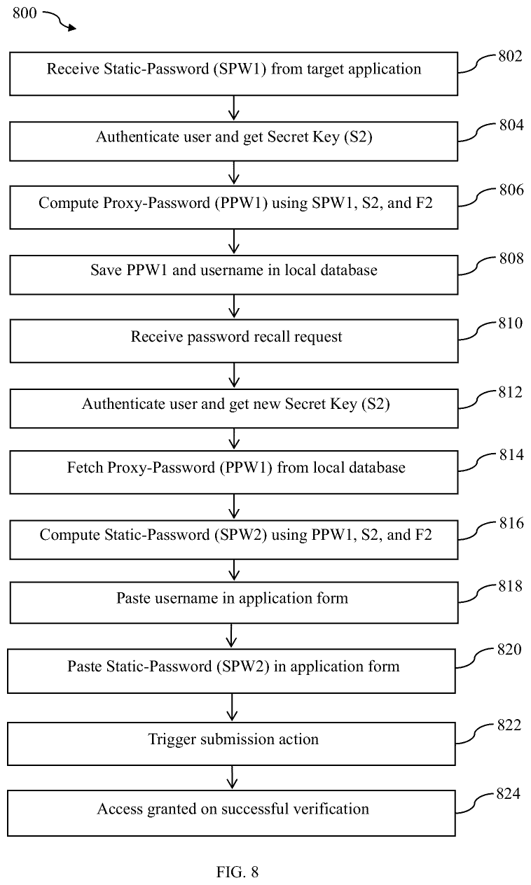

At Step 306, the processor 201 is configured for processing either a password setting request or a password saving request corresponding to a Target Application 102-1. For password setting requests, the process includes detecting application requirements, generating secure passwords that meet specific criteria, and safely storing necessary components for future password regeneration. For password saving requests, the process includes receiving an existing Static-Password (SPW1), computing a Proxy-Password (PPW1) using the Secret Key (S2), and storing this Proxy-Password securely in the local database. Both workflows leverage cryptographic functions and biometric authentication to ensure secure password management while maintaining compatibility with existing systems. The process for password setting is further elaborated with reference to FIG. 6 and the process for password saving request is further elaborated with respect to FIG. 8.

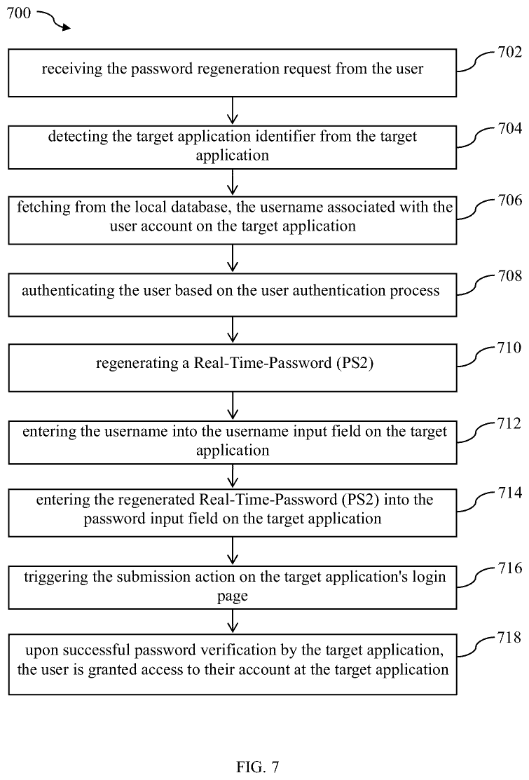

At Step 308, the processor 201 is configured for processing password regeneration requests when the user begins to login on the Target Application 102-1. This step manages two distinct password retrieval workflows. For generated passwords, the system detects the Target Application 102-1, authenticates the user through biometric verification, and regenerates the exact password using stored Random-Numbers and real-time biometric data. For saved passwords, the system retrieves the stored Proxy-Password, authenticates the user, and reconstructs the original Static-Password using the current biometric-derived Secret Key. Both workflows culminate in automatic form filling and submission, ensuring secure access without requiring password memorization by the user. The process for password regeneration and login is further elaborated with reference to FIG. 7.

At Step 310, the processor 201 is configured for processing password recall requests for previously saved passwords. This step is specifically designed for accessing stored Static-Passwords. The process begins with user authentication through biometric verification, followed by retrieval of the corresponding Proxy-Password from the local database. The system then uses the current biometric-derived Secret Key (S2) and Function (F2) to reconstruct the original Static-Password, which is then automatically filled into the target application's login form. This process ensures that saved passwords remain secure while being readily accessible to authorized users. The steps for processing password recall requests are further elaborated with reference to FIG. 8.

The method 300 creates a comprehensive system for biometric-based password management that addresses both new password generation and secure storage of existing passwords. By eliminating the need for users to remember multiple complex passwords while maintaining high security standards through biometric authentication and cryptographic techniques, the system provides a complete solution for modern password management challenges. The separation of registration, authentication, password setting, password saving, and password regeneration processes into distinct steps ensures a robust and user-friendly experience that adapts to various password management scenarios.

FIG. 4 illustrates a method 400 for registering a user, in accordance with an embodiment of the present disclosure. Method 400 corresponds to a detailed breakdown of the user registration process.

At Step 402, the processor 201 is configured for receiving a set of biometric samples from the user. These samples correspond to one or more biometric factors, which could include facial features, iris patterns, fingerprints, voice recordings, and palm vein patterns. The system may use specialized hardware such as fingerprint scanners, cameras, palm vein readers, or other biometric capture devices to capture these biometric samples with high accuracy. This step is crucial as it forms the foundation of the user's unique identity within the system.

At Step 404, the processor 201 is configured for processing the set of biometric samples to compute a Secret-Key (S1) corresponding to the user. This processing likely involves complex algorithms that extract unique features from the biometric samples and convert them into a cryptographic key. The Secret-Key (S1) is a critical component of the user's identity, as it's derived directly from their biometric data and cannot be easily replicated or guessed.

At Step 406, the processor 201 is configured for generating a Unique-Number (N1) using a random number generation algorithm. This step adds an additional layer of security to the user's identity. The random number generation algorithm likely uses a cryptographically secure method to ensure the Unique-Number is truly random and cannot be predicted. This Unique-Number serves as an additional factor in the user's identity, complementing the biometric-derived Secret-Key.

At Step 408, the processor 201 is configured for applying a Function (F1) to the Secret-Key (S1) and the Unique-Number (N1) to compute a Public-Key (P1). This function is based on Asymmetric Key Encryption principles, which means it creates a pair of keys-one public and one private. The Function (F1) consumes both the Secret-Key (S1) and the Unique-Number (N1) as inputs, combining these two unique identifiers to produce the Public-Key (P1). It's important to note that while the Public-Key is derived from the Secret-Key and Unique-Number, it's computationally infeasible to reverse this process, ensuring the security of the user's private information. It must be noted that both Function (F1) and Function (F2) are implemented as one-way cryptographic hash functions, which ensures that it is computationally infeasible to reverse engineer the Secret-Key (S2) from their outputs, adding an essential layer of security to the system.

At Step 410, the processor 201 is configured for storing the Unique-Number (N1) in two locations: on the user's device and in a data repository. Storing on the user's device allows for quick local authentication, while storing in a data repository provides a backup and allows for authentication across different devices. This dual storage approach balances convenience with security, ensuring the user can always access their account while also providing a fallback in case of device loss or failure.

At Step 412, the processor 201 is configured for storing the Public-Key (P1) on a storage device. This storage device is likely a secure server or database that associates each user's Public-Key with their account. By storing the Public-Key separately from the Secret-Key and Unique-Number, the system adds another layer of security. Even if the storage device is compromised, attackers would not have access to the information needed to reconstruct a user's full identity.

FIG. 5 illustrates a method 500 for user authentication, in accordance with an embodiment of the present disclosure. Method 500 corresponds to a detailed breakdown of the authentication process used to verify user identity.

At Step 502, the processor 201 is configured for receiving a biometric sample captured from the user in real-time. This step initiates the authentication process, where the system collects fresh biometric data from the user who is attempting to access the system. The biometric sample could be a fingerprint scan, facial recognition data, iris scan, or voice recording. This real-time capture ensures that the authentication is based on the user's current biometric characteristics, adding a layer of security against replay attacks or the use of old biometric data.

At Step 504, the processor 201 is configured for processing the biometric sample to generate a Secret-Key (S2). This processing involves complex algorithms that extract unique features from the biometric sample and convert them into a cryptographic key. The Secret-Key (S2) is a temporary key generated for this specific authentication attempt and is distinct from the Secret-Key (S1) generated during the initial registration process. This approach ensures that even if this temporary key is compromised, it doesn't affect the security of the user's overall account.

At Step 506, the processor 201 is configured for fetching the Public-Key (P1) corresponding to the user from the user device. The Public-Key (P1), which was stored on the device during the registration process, serves as the user's unique identifier within the system. By retrieving this key from the user's device, the system ensures that the authentication attempt is linked to the correct user account. This step also verifies that the authentication attempt is being made from a recognized device associated with the user.

At Step 508, the processor 201 is configured for computing a Real-Time-Unique-Number (N2) using the Public-Key (P1), the Secret-Key (S2), and the Function (F1). This step is crucial in the authentication process as it combines the user's stored identifier (P1), the freshly generated biometric key (S2), and the same cryptographic function (F1) used during registration. The Function (F1), based on Asymmetric Key Encryption principles, takes these inputs and produces a unique number that should correspond to the user's original Unique-Number if the biometric input is valid.

At Step 510, the processor 201 is configured for authenticating the user by comparing the Real-Time-Unique-Number (N2) with the Unique-Number (N1) stored on the user device. This is the final step in the authentication process where the system verifies whether the freshly computed N2 matches the N1 that was generated during registration and stored on the user's device. If these numbers match, it indicates that the current biometric input corresponds to the registered user, and the authentication is successful. If they don't match, the authentication fails, and access is denied.

This multi-factor authentication process, involving real-time biometric data, stored cryptographic keys, and on-device comparison, provides a high level of security. It ensures that access is granted only to the genuine user, based on something they are (biometric data), something they have (the device with stored keys), and something that is known only to the system (the cryptographic function). The Secret-Key (S2) generated during this authentication process serves dual purposes: it enables password regeneration for generated passwords and facilitates the reconstruction of Static-Passwords from stored Proxy-Passwords. This dual functionality ensures consistent security across both password generation and password saving workflows. The combination of factors makes it extremely difficult for an attacker to spoof or bypass the authentication process, while the unified approach to key generation maintains system security across all password management operations.

FIG. 6 illustrates a method 600 for processing password setting requests, in accordance with an embodiment of the present disclosure. Method 600 corresponds to a detailed breakdown of the steps involved in setting a Password (PS1) on a Target Application 102-1.

At Step 602, the processor 201 is configured for receiving a password setting request from the user for setting the Password (PW1) on the Target Application 102-1. This request initiates the password setting process, indicating the user's intention to create a new password for a specific application.

At Step 604, the processor 201 is configured for detecting the target application identifier from the Target Application 102-1. This identifier is unique to each application and helps the system differentiate between different applications for which the user might be setting passwords.

At Step 606, the processor 201 is configured for detecting from the Target Application 102-1, or receives through user input or an API endpoint, the username associated with the username corresponding to the target Application 102-1. This username is essential for associating the generated password with the correct user account within the Target Application 102-1.

At Step 608, the processor 201 is configured for detecting from the Target Application 102-1, or receives through user input or an API endpoint, the password length and character type requirements for the Target Application 102-1. These requirements ensure that the generated password meets the specific security criteria set by the Target Application 102-1, such as minimum length, inclusion of special characters, etc.

At Step 610, the processor 201 is configured for authenticating the user based on the user authentication process described in FIG. 5. This authentication confirms the user's identity before proceeding with the password generation.

At Step 612, the processor 201 is configured for generating the Password (PW1). For this purpose, a Random-Number (R1) is generated using a random number generation algorithm. This ensures that each password generation process starts with a unique, unpredictable value. The Random-Number (R1) is saved in a local database and associated with the user account on the Target Application 102-1. This allows the system to retrieve the correct Random-Number when the user needs to log in to the application later. Furthermore, a Unique-Number (R2) is computed using the Random-Number (R1) stored in the local database, the Secret Key (S2) derived from the user's biometric data during authentication, and a Function (F2). This computation creates a unique, time-specific value for this password generation instance. Furthermore, a transformer algorithm is applied to transform the Unique-Number (R2) into a password string that complies with the password length and character type requirements of the Target Application 102-1. This ensures that the generated password meets the application's security criteria. The transformer algorithm analyzes password requirements either received directly through the Target Application 102-1's API endpoint or through pattern matching of the application's password policy page. It identifies all required character types including uppercase letters, lowercase letters, numbers, and special characters. The algorithm determines both minimum and maximum password length requirements, verifies password complexity rules including restrictions on consecutive characters and pattern repetitions, and validates the generated passwords against all identified requirements before submission.

At Step 614, the processor 201 is configured for entering the username into the username input field on the Target Application 102-1, automating the form filling process.

At Step 616, the processor 201 is configured for entering the generated Password (PW1) into the password input field on the Target Application 102-1.

At Step 618, the processor 201 is configured for triggering the submission action on the Target Application 102-1, completing the password setting process.

This automated password setting process, guided by the user's biometric authentication, provides a secure and user-friendly way to create strong, application-specific passwords without requiring the user to remember them. The use of random numbers, real-time biometric keys, and application-specific requirements ensures that each password is unique, complex, and compliant with security standards.

FIG. 7 illustrates a method 700 for processing a password regeneration request, in accordance with an embodiment of the present disclosure. Method 700 corresponds to a detailed breakdown of the steps involved when a user begins to login to a Target Application 102-1 using the system. 100.

At Step 702, the processor 201 is configured for receiving the password regeneration request from the user when the user begins to login to the Target Application 102-1. This request is triggered at the initiation of the login process. 101. At

Step 704, the processor 201 is configured for detecting the target application identifier from the Target Application 102-1. This identifier is essential for retrieving the correct credentials for the specific application being accessed. 102.

At Step 706, the processor 201 is configured for fetching, from the local database, the username associated with the user account on the Target Application 102-1 based on the target application identifier. This step ensures that the correct credentials are retrieved for the specific application-user combination.

At Step 708, the processor 201 is configured for authenticating the user based on the user authentication process described in FIG. 5. Upon successful authentication, the method retrieves the Secret Key (S2) generated in real-time based on the user's current biometric data. This real-time generation of the Secret Key ensures that only the legitimate user can initiate the password regeneration process. 104.

At Step 710, the processor 201 is configured for regenerating the Real-Time-Password through a multi-step process. First, the Random-Number (R1) associated with the user account on the Target Application 102-1 is fetched from the local database where it was stored during the initial password setting process. Next, a Unique-Number (R2) is computed using the retrieved Random-Number (R1), the current Secret Key (S2) obtained from the user's real-time biometric data, and Function (F2). Finally, the transformer algorithm is applied to the Unique-Number (R2) to regenerate the Real-Time-Password. This transformation ensures that the regenerated password exactly matches the one initially set for this user on the Target Application 102-1 while maintaining compliance with the application's password requirements. 105.

At Step 712, the processor 201 is configured for entering the username into the username input field on the Target Application 102-1. This step initiates the automated form-filling process, reducing user interaction and potential input errors. 106.

At Step 714, the processor 201 is configured for entering the regenerated Real-Time-Password (PW2) into the password input field on the Target Application 102-1. The system ensures secure transmission of the regenerated password to the application interface. 107.

At Step 716, the processor 201 is configured for triggering the submission action on the target application's login form. This automated submission ensures proper timing and execution of the login process. 108.

At Step 718, upon successful password verification by the Target Application 102-1, the user is granted access to their account. This step confirms that the regenerated password matches the originally set password, validating the entire regeneration process. 109. This password regeneration process provides a secure and seamless way for users to access their accounts without having to remember or manually enter complex passwords. The use of real-time biometric authentication ensures that only the authorized user can initiate password regeneration, while the cryptographic combination of stored Random-Numbers and biometric-derived Secret Keys maintains the uniqueness and strength of each password. The automation of form filling and submission enhances the user experience by streamlining the login process while maintaining robust security standards. The entire process occurs in a secure environment where sensitive cryptographic materials are processed in protected memory and immediately discarded after use, ensuring that no residual password data remains accessible after the login process completes.

FIG. 8 illustrates a method 800 for processing a password saving request, in accordance with an embodiment of the present disclosure. Method 800 corresponds to a detailed breakdown of the steps involved in securely saving an existing Static-Password (SPW1) and subsequently recalling it for use with a Target Application 102-1. The method 800 is divided into two main phases: the password saving phase and the password recall phase. Each phase requires biometric authentication and implements secure cryptographic transformations to protect the stored password data.

At Step 802, the processor 201 is configured for receiving a Static-Password (SPW1) from the target application. This Static-Password corresponds to a username of the user on the target application and represents an existing password that the user wants to store securely in the system. The system maintains a strict one-to-one mapping between Static-Passwords and their corresponding usernames within the context of each target application. When a Static-Password (SPW1) is received from a target application, the system immediately associates it with the specific username of the user on that application, ensuring that subsequent password recall operations can accurately retrieve and reconstruct the correct password for each username-application combination.

At Step 804, the processor 201 is configured for authenticating the user based on the user authentication process described in FIG. 5. Upon successful authentication, the system retrieves the Secret Key (S2) generated in real-time based on the user's biometric data.

At Step 806, the processor 201 is configured for computing a Proxy-Password (PPW1) using the Static-Password (SPW1), the Secret Key (S2), and Function (F2). This computation creates a secure representation of the original password that can only be reversed with the correct biometric input.

At Step 808, the processor 201 is configured for saving the Proxy-Password (PPW1) along with the username in the local database. The original Static-Password is immediately discarded from memory after the Proxy-Password is generated and stored.

The password recall phase begins at Step 810, where the processor 201 is configured for receiving a password recall request from the user. This request is initiated when the user needs to access the previously saved password.

At Step 812, the processor 201 is configured for authenticating the user based on the user authentication process and retrieving a fresh Secret Key (S2) generated in real-time based on the current biometric sample.

At Step 814, the processor 201 is configured for fetching the Proxy-Password (PPW1) from the local database. This retrieval is performed using secure database access protocols to protect the stored credential data.

At Step 816, the processor 201 is configured for using the Proxy-Password (PPW1), the current Secret Key (S2), and Function (F2) to compute the Static-Password (SPW2). This computation reverses the original transformation, recreating the exact password that was originally saved. In the context of password saving operations, Function (F2) implements a specialized form of asymmetric encryption that enables both the secure transformation of Static-Passwords into Proxy-Passwords and their subsequent reconstruction. The function's bidirectional capability in this context is carefully designed to maintain security while allowing authorized reconstruction of the original password through proper biometric authentication.

When applied in the context of password saving operations, Function (F2) implements additional security measures specific to Static-Password handling. The function employs a specialized transformation pipeline that first validates the Static-Password against application-specific requirements, then applies the cryptographic transformation using the Secret Key (S2). This process ensures that the resulting Proxy-Password retains the security properties necessary for both storage and subsequent reconstruction while maintaining the ability to recreate the exact original password when needed. The function's implementation includes safeguards against timing attacks and side-channel analysis, ensuring that the password transformation process remains secure even under sophisticated attack scenarios.

At Step 818, the processor 201 is configured for pasting the username in the username input field on the target application, initiating the automated form-filling process.

At Step 820, the processor 201 is configured for pasting the reconstructed Static-Password (SPW2) in the password input field on the target application.

At Step 822, the processor 201 is configured for triggering a submission action on the target application, completing the login process.

At Step 824, the user obtains access to the target application based on successful password verification. This final step confirms that the password reconstruction process has accurately reproduced the original Static-Password.

This password saving and recall mechanism provides a secure way to store existing passwords while maintaining the security benefits of biometric authentication. The use of Proxy-Passwords ensures that actual password values are never stored directly in the system, while the biometric-derived Secret Keys ensure that only the legitimate user can reconstruct the original passwords. The entire process maintains security while providing a seamless user experience through automated form filling and submission.

Although implementations for the system and the method for generating passwords in real-time based on biometric factors have been described in language specific to structural features and methods, it must be understood that the claims are not limited to the specific features or methods described. Rather, the specific features and methods are disclosed as examples of implementations for the system and the method for generating passwords in real-time based on biometric factors.

1. A system for generating passwords in real-time based on biometric factors, the system comprising:
a processor and a memory coupled to the processor, wherein the processor is configured to execute instructions stored in the memory for:
registering a user based on a user registration process, wherein the user registration process comprises steps of:
receiving a set of biometric samples of the user, corresponding to one or more biometric factors,
processing the set of biometric samples to compute a Secret-Key (S1) corresponding to the user,
generating a Unique-Number (N1) using a random number generation algorithm,
applying a Function (F1) to the Secret-Key (S1) and the Unique-Number (N1) to compute a Public-Key (P1),
storing the Unique-Number (N1) on a user device and in a data repository, and
storing the Public-Key (P1) on a storage device;
authenticating the user based on a user authentication process, wherein the user authentication process comprises steps of:
receiving a biometric sample captured from the user in real-time,
processing the biometric sample to generate a Secret-Key (S2),
fetching the Public-Key (P1) corresponding to the user from the user device,
computing a Real-Time-Unique-Number (N2) using the Public-Key (P1), the Secret-Key (S2) and the Function (F1), and
authenticating the user based in comparison of the Real-Time-Unique-Number (N2) with the Unique-Number (N1) stored on the user device;
receiving a password setting request or a password saving request corresponding to a target application, wherein the password setting request corresponds to setting a Password (PW1) on the target application, and wherein the password setting request is processed by:
receiving the password setting request from the user for setting the Password (PW1) on the target application,
detecting from the target application, a target application identifier,
detecting from the target application, or receiving, through user input, or through an API endpoint, a username associated with a username corresponding to the target application,
detecting from the target application, or receiving, through user input, or through an API endpoint, password length and character type requirements for the target application;
authenticating the user based on the user authentication process;
generating the Password (PW1) by:
generating a Random-Number (R1) using a random number generation algorithm,
saving the Random-Number (R1) in a local database and associating the Random-Number (R1) with the username corresponding to the target application,
computing a Unique-Number (R2) using the Random-Number (R1) stored in the local database, the Secret Key (S2), and a Function (F2),
transforming the Unique-Number (R2) into the Password (PW1), wherein the Password (PW1) complies with the password length and character type requirements for the target application,
pasting the username in the username input field on the target application,
pasting the Password (PW1) in the password input field on the target application, and
triggering the submission action on the target application for setting the Password (PW1) on the target application;
processing a password regeneration request from the user when the user begins to login on the target application, wherein the password regeneration request is processed by:
receiving the password regeneration request from the user,
detecting from the target application, the target application identifier,
fetching, from the local database, the username associated with the user account on the target application based on the target application identifier,
authenticating the user based on the user authentication process and retrieving the Secret Key (S2) generated in real-time based on the user authentication process,
regenerating a Real-Time-Password (PW2) by:
fetching, from the local database, the Random-Number (R1) associated with the user account on the target application,
computing the Unique-Number (R2) using the Random-Number (R1) stored on the local device, the Secret Key (S2), and the Function (F2),
transforming the Unique-Number (R2), and
regenerating the Real-Time-Password,
pasting the username in the username input field on the target application;
pasting the Real-Time-Password (PW2) in the password input field on the target application; and
triggering a submission action on the target application,
wherein the user obtains access to the target application based on successful password verification.

2. The system of claim 1, wherein the password saving request is processed by
receiving a Static-Password (SPW1) from the target application, wherein the Static-Password (SPW1) corresponds to a username of the user on the target application;
authenticating the user based on the user authentication process and retrieving the Secret Key (S2) generated in real-time based on the user authentication process;
computing a Proxy-Password (PPW1) using the Static-Password (SPW1), the Secret Key (S2), and a Function (F2),
Saving the Proxy-Password (PPW1) along with the username in a local database;
receiving a password recall request from the user, wherein the password recall request is processed by
authenticating the user based on the user authentication process and retrieving the Secret Key (S2) generated in real-time based on the user authentication process;
fetching the Proxy-Password (PPW1) from the local database;
using the Proxy-Password (PPW1), the Secret Key (S2), and a Function (F2) to compute a Static-Password (SPW2);
pasting the username in the username input field on the target application;
pasting the Static-Password (SPW2) in the password input field on the target application; and
triggering a submission action on the target application, wherein the user obtains access to the target application based on successful password verification.

3. The system of claim 1, wherein the one or more biometric factors correspond to face, voice, retina, fingerprint, and palm vein, wherein the set of biometric samples are captured by the user device.

4. The system of claim 1 is further configured for generating the Real-Time-Password (PW2) by:
receiving password requirements from the target application,
identifying required character types including uppercase letters, lowercase letters, numbers, and special characters,
determining minimum and maximum password length requirements,
determining password complexity rules including restrictions on consecutive characters and pattern, and
applying a transformer algorithm to generate the Real-Time-Password (PW2) compliant with the password requirements.

5. The system of claim 1, wherein the Function (F1) and Function (F2) are functions based on Asymmetric Key Encryption.

6. A method for generating passwords in real-time based on biometric factors, the method comprising steps of:
registering a user based on a user registration process, wherein the user registration process comprises steps of:
receiving a set of biometric samples of the user, corresponding to one or more biometric factors,
processing the set of biometric samples to compute a Secret-Key (S1) corresponding to the user,
generating a Unique-Number (N1) using a random number generation algorithm,
applying a Function (F1) to the Secret-Key (S1) and the Unique-Number (N1) to compute a Public-Key (P1),
storing the Unique-Number (N1) on a user device and in a data repository, and
storing the Public-Key (P1) on a storage device;
authenticating the user based on a user authentication process, wherein the user authentication process comprises steps of:
receiving a biometric sample captured from the user in real-time,
processing the biometric sample to generate a Secret-Key (S2),
fetching the Public-Key (P1) corresponding to the user from the user device,
computing a Real-Time-Unique-Number (N2) using the Public-Key (P1), the Secret-Key (S2) and the Function (F1), and
authenticating the user based in comparison of the Real-Time-Unique-Number (N2) with the Unique-Number (N1) stored on the user device;
receiving a password setting request or a password saving request corresponding to a target application, wherein the password setting request corresponds to setting a Password (PW1) on the target application, and wherein the password setting request is processed by:
receiving the password setting request from the user for setting the Password (PW1) on the target application,
detecting from the target application, a target application identifier,
detecting from the target application, or receiving, through user input, or through an API endpoint, a username associated with a username corresponding to the target application,
detecting from the target application, or receiving, through user input, or through an API endpoint, password length and character type requirements for the target application;
authenticating the user based on the user authentication process;
generating the Password (PW1) by:
generating a Random-Number (R1) using a random number generation algorithm,
saving the Random-Number (R1) in a local database and associating the Random-Number (R1) with the username corresponding to the target application,
computing a Unique-Number (R2) using the Random-Number (R1) stored in the local database, the Secret Key (S2), and a Function (F2),
transforming the Unique-Number (R2) into the Password (PW1), wherein the Password (PW1) complies with the password length and character type requirements for the target application,
pasting the username in the username input field on the target application,
pasting the Password (PW1) in the password input field on the target application, and
triggering the submission action on the target application for setting the Password (PW1) on the target application;
processing a password regeneration request from the user when the user begins to login on the target application, wherein the password regeneration request is processed by:
receiving the password regeneration request from the user, detecting from the target application, the target application identifier,
fetching, from the local database, the username associated with the user account on the target application based on the target application identifier,
authenticating the user based on the user authentication process and retrieving the Secret Key (S2) generated in real-time based on the user authentication process,
regenerating a Real-Time-Password (PW2) by:
fetching, from the local database, the Random-Number (R1) associated with the user account on the target application,
computing the Unique-Number (R2) using the Random-Number (R1) stored on the local device, the Secret Key (S2), and the Function (F2),
transforming the Unique-Number (R2), and
regenerating the Real-Time-Password,
pasting the username in the username input field on the target application;
pasting the Real-Time-Password (PW2) in the password input field on the target application; and
triggering a submission action on the target application, wherein the user obtains access to the target application based on successful password verification.

7. The method of claim 6, wherein the password saving request is processed by
receiving a Static-Password (SPW1) from the target application, wherein the Static-Password (SPW1) corresponds to a username of the user on the target application;
authenticating the user based on the user authentication process and retrieving the Secret Key (S2) generated in real-time based on the user authentication process;
computing a Proxy-Password (PPW1) using the Static-Password (SPW1), the Secret Key (S2), and a Function (F2),
Saving the Proxy-Password (PPW1) along with the username in a local database;
receiving a password recall request from the user, wherein the password recall request is processed by
authenticating the user based on the user authentication process and retrieving the Secret Key (S2) generated in real-time based on the user authentication process;
fetching the Proxy-Password (PPW1) from the local database;
using the Proxy-Password (PPW1), the Secret Key (S2), and a Function (F2) to compute a Static-Password (SPW2);
pasting the username in the username input field on the target application;
pasting the Static-Password (SPW2) in the password input field on the target application; and
triggering a submission action on the target application, wherein the user obtains access to the target application based on successful password verification.

8. The method of claim 6, wherein the one or more biometric factors correspond to face, voice, retina, fingerprint, and palm vein, wherein the set of biometric samples are captured by the user device.

9. The method of claim 6 further comprises steps for generating the Real-Time-Password (PW2) by:
receiving password requirements from the target application,
identifying required character types including uppercase letters, lowercase letters, numbers, and special characters,
determining minimum and maximum password length requirements,
determining password complexity rules including restrictions on consecutive characters and pattern, and
applying a transformer algorithm to generate the Real-Time-Password (PW2) compliant with the password requirements

10. The method of claim 6, wherein the Function (F1) and Function (F2) are functions based on Asymmetric Key Encryption.

11. A computer program product having a processor and a non-transitory, machine-readable storage medium for generating passwords in real-time based on biometric factors, the computer program product comprising a program code for:
registering a user based on a user registration process, wherein the user registration process comprises steps of:
receiving a set of biometric samples of the user, corresponding to one or more biometric factors,
processing the set of biometric samples to compute a Secret-Key (S1) corresponding to the user,
generating a Unique-Number (N1) using a random number generation algorithm,
applying a Function (F1) to the Secret-Key (S1) and the Unique-Number (N1) to compute a Public-Key (P1),
storing the Unique-Number (N1) on a user device and in a data repository, and
storing the Public-Key (P1) on a storage device;
authenticating the user based on a user authentication process, wherein the user authentication process comprises steps of:
receiving a biometric sample captured from the user in real-time,
processing the biometric sample to generate a Secret-Key (S2),
fetching the Public-Key (P1) corresponding to the user from the user device,
computing a Real-Time-Unique-Number (N2) using the Public-Key (P1), the Secret-Key (S2) and the Function (F1), and
authenticating the user based in comparison of the Real-Time-Unique-Number (N2) with the Unique-Number (N1) stored on the user device;
receiving a password setting request or a password saving request corresponding to a target application, wherein the password setting request corresponds to setting a Password (PW1) on the target application, and wherein the password setting request is processed by:
receiving the password setting request from the user for setting the Password (PW1) on the target application,
detecting from the target application, a target application identifier,
detecting from the target application, or receiving, through user input, or through an API endpoint, a username associated with a username corresponding to the target application,
detecting from the target application, or receiving, through user input, or through an API endpoint, password length and character type requirements for the target application;
authenticating the user based on the user authentication process;
generating the Password (PW1) by:
generating a Random-Number (R1) using a random number generation algorithm,
saving the Random-Number (R1) in a local database and associating the Random-Number (R1) with the username corresponding to the target application,
computing a Unique-Number (R2) using the Random-Number (R1) stored in the local database, the Secret Key (S2), and a Function (F2),
transforming the Unique-Number (R2) into the Password (PW1), wherein the Password (PW1) complies with the password length and character type requirements for the target application,
pasting the username in the username input field on the target application,
pasting the Password (PW1) in the password input field on the target application, and
triggering the submission action on the target application for setting the Password (PW1) on the target application;
processing a password regeneration request from the user when the user begins to login on the target application, wherein the password regeneration request is processed by:
receiving the password regeneration request from the user,
detecting from the target application, the target application identifier,
fetching, from the local database, the username associated with the user account on the target application based on the target application identifier,
authenticating the user based on the user authentication process and retrieving the Secret Key (S2) generated in real-time based on the user authentication process,
regenerating a Real-Time-Password (PW2) by:
fetching, from the local database, the Random-Number (R1) associated with the user account on the target application,
computing the Unique-Number (R2) using the Random-Number (R1) stored on the local device, the Secret Key (S2), and the Function (F2),
transforming the Unique-Number (R2), and regenerating the Real-Time-Password,
pasting the username in the username input field on the target application;
pasting the Real-Time-Password (PW2) in the password input field on the target application; and
triggering a submission action on the target application, wherein the user obtains access to the target application based on successful password verification.
